(19) United States
(12) Patent Application Publication
(10) Pub. No.: US 2026/0287993 A1
(43) Pub. Date: Sep. 24, 2026

(54) PROJECTOR

(71) Applicant: SEIKO EPSON CORPORATION, Tokyo (JP)

(72) Inventor: Sosei YAMANE, MINOWA-MACHI (JP)

(21) Appl. No.: 19/572,946

(22) Filed: Mar. 20, 2026

(30) Foreign Application Priority Data
Mar. 21, 2025 (JP) 2025-046675

(51) Int. Cl. G03B 21/16; G03B 21/20

(52) U.S. Cl. CPC G03B 21/16; G03B 21/2013

(57) ABSTRACT

A projector includes a plurality of light sources; a drive element configured to control driving of the plurality of light sources; an integrated circuit element configured to control the drive element; a main board on which the drive element and the integrated circuit element are mounted; a housing configured to house the plurality of light sources and the main board; a partition section configured to partition an internal space of the housing into a first cooling flow path and a second cooling flow path; a first cooling device configured to cool the first cooling flow path; and a second cooling device configured to cool the second cooling flow path. An amount of heat released to the second cooling flow path is larger than an amount of heat released to the first cooling flow path and the second cooling device’s cooling capacity is higher than the first cooling device’s cooling capacity.

### CROSS-REFERENCE TO RELATED APPLICATION

The present application is based on, and claims priority from JP Application Serial Number 2025-046675, filed Mar. 21, 2025, the disclosure of which is hereby incorporated by reference herein in its entirety.

### BACKGROUND

### 1. Technical Field

The present disclosure relates to a projector.

### 2. Related Art

JP-A-2023-096574 disclose a projector in which a first cooling target accommodated in a first accommodation section and a second cooling target accommodated in a second accommodation section are disposed such that the first cooling target is disposed on an inflow side of an air current with respect to an intake fan and the second cooling target is disposed on an outflow side of the air current with respect to the intake fan. JP-A-2023-096574 discloses a configuration in which a light source device and an image forming device are set as a second cooling target.

In JP-A 2023-096574, a part of the air current flowing out from the intake fan is supplied to the light source device, and another part of the air current is supplied to the image forming device. Since there is one light source device, there is provided one fan for cooling the light source device. However, in the case where a plurality of light source devices are provided, there is a problem that the device increases in size when the number of fans is increased in accordance with the number of light source devices. Therefore, there is a demand for a projector capable of effectively cooling a plurality of light source devices when the plurality of light source devices are provided.

### SUMMARY

To achieve the above objective, one aspect of the present disclosure includes a plurality of light sources; a drive element configured to control driving of the plurality of light sources; an integrated circuit element configured to control the drive element; a main board on which the drive element and the integrated circuit element are mounted; a housing configured to house the plurality of light sources and the main board; a partition section configured to partition an internal space of the housing into a first cooling flow path and a second cooling flow path; a first cooling device configured to cool the first cooling flow path; and a second cooling device configured to cool the second cooling flow path, wherein an amount of heat released to the second cooling flow path is larger than an amount of heat released to the first cooling flow path and a cooling capacity of the second cooling device is higher than a cooling capacity of the first cooling device.

### BRIEF DESCRIPTION OF THE DRAWINGS

FIG. 1 is a perspective view of a projector according to an embodiment in a front view.

FIG. 2 is a perspective view of the projector according to the embodiment in a back view.

FIG. 3 is an explanatory diagram illustrating an optical configuration of the projector according to the embodiment.

FIG. 4 is a perspective view illustrating a state in which a projector main body according to the embodiment is rotated.

FIG. 5 is a perspective view illustrating a lower portion of the projector according to the embodiment.

FIG. 6 is a top view illustrating a top surface of a housing with a cover removed.

FIG. 7 is a cross-sectional view taken along line VII-VII in FIG. 6.

FIG. 8 is a diagram illustrating the projector main body from which the housing and the cover are removed.

FIG. 9 is a plan view of a main board as viewed from above in an opposing direction.

FIG. 10 is a perspective view illustrating the auxiliary board.

FIG. 11 is a plan view illustrating the projector main body from which the cover and the main board are removed.

FIG. 12 is a schematic plan view of cooling elements in the first cooling flow path and the second cooling flow path.

FIG. 13 is a cross-sectional view taken along line VIII-VIII in FIG. 12.

FIG. 14 is a block diagram illustrating a configuration of boards.

### DESCRIPTION OF EMBODIMENTS

### Embodiment of Projector

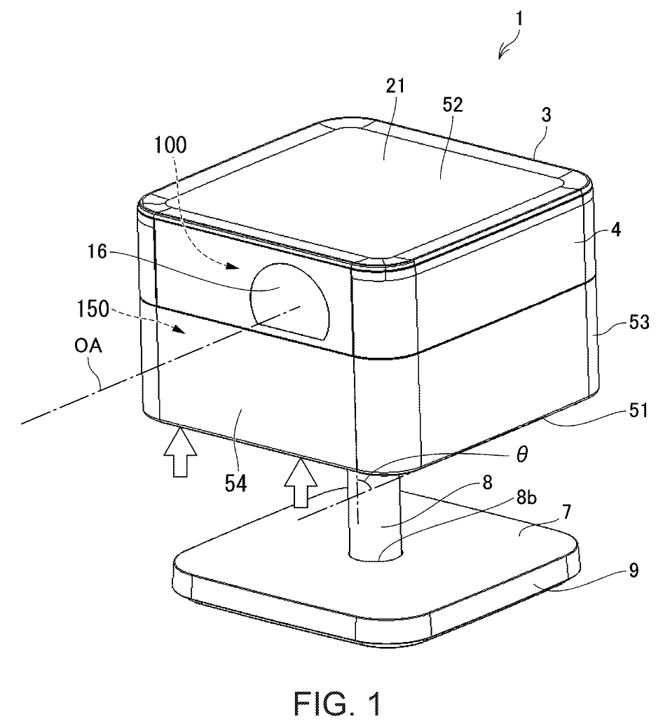

A projector according to a embodiment will be described below with reference to FIGS. 1 to 4.

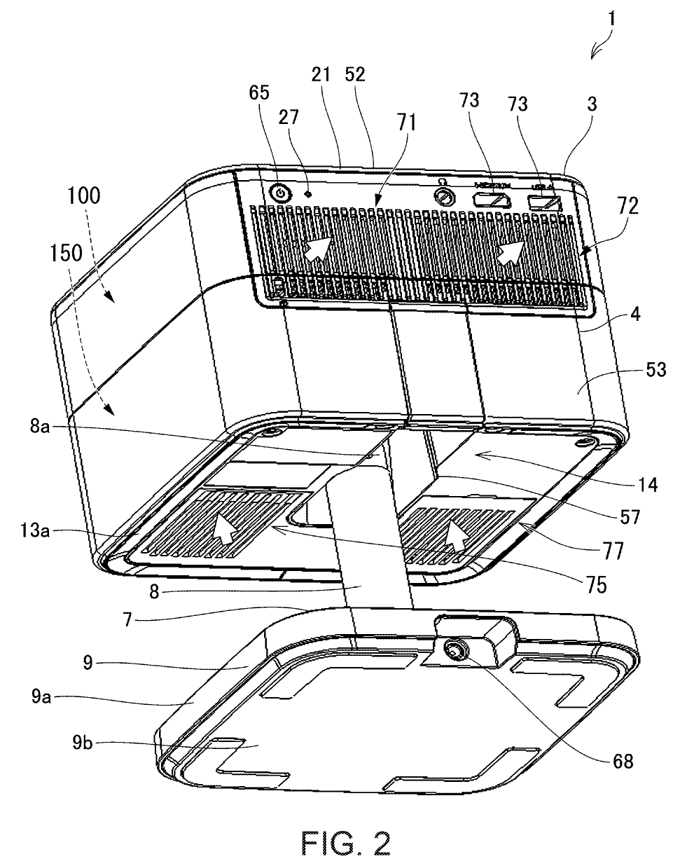

FIG. 1 is a perspective view of the projector 1 in a front view. FIG. 2 is a perspective view of the projector 1 in a back view.

### 1. Projector main body

A projector 1 is for home use, for example, and is used by being placed on a side table of a bed in a bedroom, for example.

The projector 1 includes a projector main body 3 having a rectangular box shape and a leg section 7 that supports the projector main body 3. The projector main body 3 includes a housing 4 having a substantially rectangular parallelepiped shape, a cover 21 that covers a top surface 52 of the housing 4, and an optical device 100 and an acoustic device 150 housed in the housing 4. The optical device 100 is disposed on the upper side in a height direction in the housing 4. The acoustic device 150 is disposed on the upper side in the height direction in the housing 4. The top surface section of the projector main body 3 has a double structure formed of the top surface 52 of the housing 4 and the cover 21.

As illustrated in FIG. 1, a projection lens 16 for projecting image light is provided on a front surface 54 of the projector main body 3. FIG. 1 illustrates an optical axis OA of the image light projected by the projection lens 16 onto the projection surface. The optical axis OA is a central axis of a projection image, and is, for example, a virtual axis passing through the optical center of the projection lens 16. In FIG. 1, an image projected by the projector main body 3 is projected forward, and the optical axis OA is parallel to an installation surface of the projector 1.

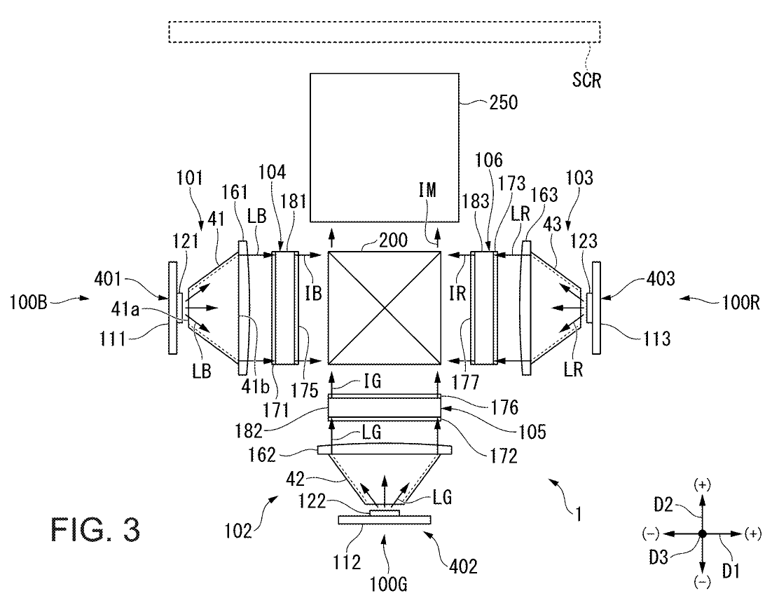

FIG. 3 is an explanatory diagram illustrating an optical configuration of the projector main body 3. The optical configuration is accommodated in the projector main body 3.

The optical device 100 of the projector main body 3 includes a first image forming module 100B, a second image forming module 100G, a third image forming module 100R, a light combining element 200, and a projection optical system 250, as illustrated in FIG. 3.

The first image forming module 100B includes a blue light emitting section 101 and a blue light modulation device 104. The second image forming module 100G includes a green light emitting section 102 and a green light modulation device 105. The third image forming module 100R includes a red light emitting section 103 and a red light modulation device 106.

First, the first image forming module 100B will be described. The blue light emitting section 101 of the first image forming module 100B emits blue light LB. In the following description, a direction parallel to an optical axis of the blue light LB emitted from the blue light emitting section 101 is defined as a D1 direction. Assuming that one side in the D1 direction is a -D1 side, and the opposite side to the -D1 side in the D1 direction is defined as a +D1 side. A direction orthogonal to the D1 direction in a plane including the optical axis of the blue light LB is defined as a D2 direction. Assuming that one side in the D2 direction is a -D2 side, and the opposite side to the -D2 side in the D2 direction is defined as a +D2 side. A direction orthogonal to the D1 direction and the D2 direction is defined as D3 direction. The blue light LB emitted from the blue light emitting section 101 travels toward the +D1 side along the D1 direction.

The blue light emitting section 101 has a first light source 401, a first light guide element 41, and a first parallelizing element 161. A first light emitter 121 of the first light source 401 is supported by a first board 111. The first board 111 is a plate including a plane parallel to the D2 direction and the D3 direction.

The first light emitter 121 is provided on a plate surface of the first board 111 on the +D1 side. A light emitting surface of the first light emitter 121 is a surface on the +D1 side, which is the opposite side than the surface provided on the first board 111. The first light emitter 121 emits the blue light LB in a blue wavelength band in the visible wavelength band. The blue wavelength band corresponds to a first wavelength band. The blue light LB corresponds to first light. The blue light LB is emitted toward the +D1 side around the axis passing through the centers of the light emitting surface of the first light emitter 121 and parallel to the D1 direction. The blue wavelength band is, for example, a wavelength band from 420nm to 500nm. The blue wavelength band has the shortest wavelength among the color lights used in the three plate projector, and thus, has high energy.

The first light emitter 121 is formed of, for example, an LED that emits the blue light LB. Note that the first light emitter 121 may be constituted by one LED or may be constituted by all of a plurality of LEDs. In the case where the first light emitter 121 is configured by a plurality of LEDs, the LEDs are arranged in a region occupied by the first light emitter 121 in a plane including the D2 direction and the D3 direction.

The first light guide element 41 is provided in the optical path of the blue light LB emitted from the first light source 401 and is disposed in a position that is on the +D1 side from the first light emitter 121 of the first light source 401 and that overlaps the first light emitter 121 in the D2 direction and the D3 direction. The first light guide element 41 restricts the light guide path for guiding the blue light LB emitted from the first light emitter 121 and causes the blue light LB to propagate toward a first light modulation element 181.

The first parallelizing element 161 is provided on the optical path of the blue light LB emitted from the first light guide element 41. The first parallelizing element 161 parallelizes the blue light LB emitted from the first light guide element 41 along the D1 direction.

The blue light modulation device 104 has a first incident side polarization element 171, the first light modulation element 181, and a first emission side polarization element 175. The blue light modulation device 104 is provided on the optical path of the blue light LB emitted from the first parallelizing element 161.

The first incident side polarization element 171 is disposed on the +D1 side of the first parallelizing element 161. The first incident side polarization element 171 emits predetermined polarized light of the blue light LB emitted from the first parallelizing element 161 toward the +D1 side along the D1 direction. The first incident side polarization element 171 is, for example, a reflective polarizing plate or an absorptive polarizing plate.

The first light modulation element 181 is disposed on the +D1 side of the first incident side polarization element 171. The first light modulation element 181 modulates the blue light LB emitted from the first incident side polarization element 171. The first light modulation element 181 is, for example, a transmissive liquid crystal panel. The liquid crystal panel constituting the first light modulation element 181 modulates light based on blue image information to generate blue image light IB. The first light modulation element 181 emits the generated image light IB toward the +D1 side along the D1 direction.

The first emission side polarization element 175 is disposed on the +D1 side of the first light modulation element 181. The first emission side polarization element 175 emits predetermined polarized light of the image light IB emitted from the first light modulation element 181 toward the +D1 side along the D1 direction. The first emission side polarization element 175 is, for example, a reflective polarizing plate or an absorptive polarizing plate.

Next, the second image forming module 100G will be described. The green light emitting section 102 of the second image forming module 100G is disposed on the +D1 side and the -D2 side from the blue light emitting section 101, and is disposed in a region overlapping the blue light emitting section 101 in the D3 direction. The green light emitting section 102 emits green light LG. The green light LG emitted from the green light emitting section 102 travels toward the +D2 side along the D2 direction.

The green light emitting section 102 has a second light source 402, a second light guide element 42, and a second parallelizing element 162. A second light emitter 122 of the second light source 402 is supported by a second board 112. The second board 112 is a plate including a plane parallel to the D2 direction and the D3 direction.

The second light emitter 122 is provided on a plate surface of the second board 112 on the +D1 side. A light emitting surface of the second light emitter 122 is a surface on the +D1 side, which is the opposite side from the surface provided on the second board 112. The second light emitter 122 emits green light LG in a green wavelength band in the visible wavelength band. The green wavelength band corresponds to a second wavelength band. The green light LG corresponds to second light. The green light LG is emitted toward the +D2 side around the axis passing through the centers of the light emitting surface of the second light emitter 122 and parallel to the D2 direction. The green wavelength band is, for example, a wavelength band from 500nm to 600nm. Since the green wavelength band is easily recognized by the human eye, a large amount of light is required when the green wavelength band is projected on a screen SCR. Similarly to the first light emitter 121, the second light emitter 122 is formed of, for example, an LED that emits the green light LG.

The second light guide element 42 is provided on the optical path of the green light LG emitted from the second light source 402. The second light guide element 42 restricts the light guide path for guiding the green light LG emitted from the second light emitter 122 and causes the green light LG to propagate to a second light modulation element 182.

The second parallelizing element 162 parallelizes the green light LG emitted from the second light guide element 42 along the D2 direction, as with the first parallelizing element 161.

The green light modulation device 105 has a second incident side polarization element 172, the second light modulation element 182, and a second emission side polarization element 176. The green light modulation device 105 is provided on the optical path of the green light LG emitted from the second parallelizing element 162.

The second incident side polarization element 172 emits predetermined polarized light out of the green light LG emitted from the second parallelizing element 162 toward the +D2 side along the D2 direction, similarly to the first incident side polarization element 171.

The second light modulation element 182 modulates the green light LG emitted from the second incident side polarization element 172, similarly to the first light modulation element 181. The second light modulation element 182 generates green image light IG based on green image information. The second light modulation element 182 emits the image light IG toward the +D2 side along the D2 direction.

The second emission side polarization element 176 emits predetermined polarized light out of the image light IG emitted from the second light modulation element 182 toward the +D2 side along the D2 direction, similarly to the first emission side polarization element 175.

Next, the third image forming module 100R will be described. The red light emitting section 103 of the third image forming module 100R is disposed on the +D1 side from the green light emitting section 102, and is disposed in a region overlapping the blue light emitting section 101 in the D2 direction and the D3 direction. The red light emitting section 103 emits red light LR. The red light LR emitted from the red light emitting section 103 travels toward the -D1 side along the D1 direction.

The red light emitting section 103 has a third light source 403, a third light guide element 43, and a third parallelizing element 163. A third light emitter 123 of the third light source 403 is supported by a third board 113. The third board 113 is a plate including a plane parallel to the D2 direction and the D3 direction.

The third light emitter 123 is provided on a plate surface of the third board 113 on the +D1 side. A light emitting surface of the third light emitter 123 is a surface on the +D1 side, which is the opposite side from the surface provided on the third board 113. The third light emitter 123 emits red light LR in a red wavelength band in the visible wavelength band. The red wavelength band corresponds to a third wavelength band. The red light LR corresponds to third light. The red light LR is emitted toward the -D1 side around the axis passing through the centers of the light emitting surface of the third light emitter 123 and parallel to the D1 direction. The red wavelength band is, for example, a wavelength band from 610nm to 700nm. The third light emitter 123 is formed of, for example, an LED that emits red light LR, similarly to the first light emitter 121 and the second light emitter 122.

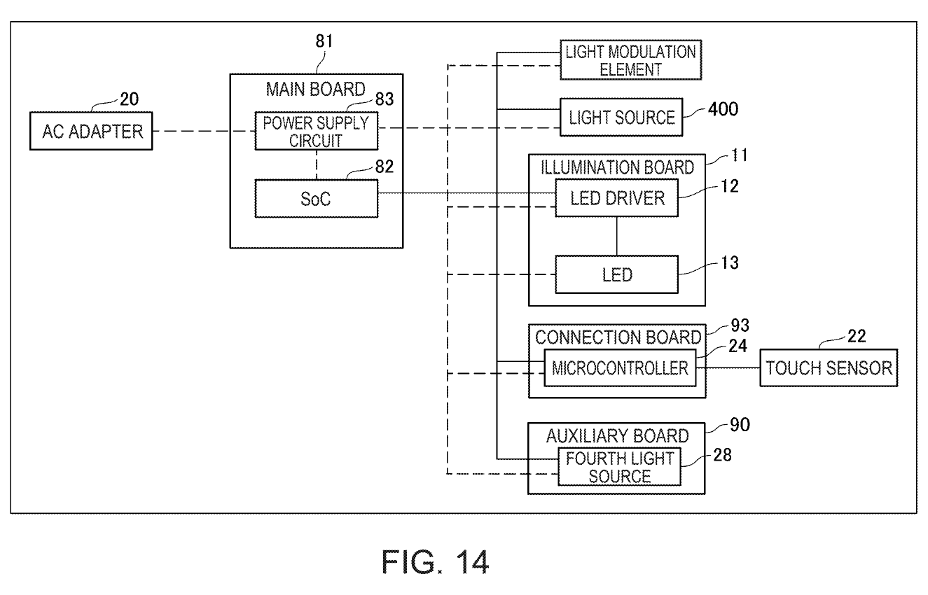

The third light guide element 43 is provided on the optical path of the red light LR emitted from the third light source 403. The third light guide element 43 restricts the light guide path for guiding the red light LR emitted from the third light emitter 123 and causes the red light LR to propagate to a third light modulation element 183. The first light source 401, the second light source 402, and the third light source 403 constitute a light source 400 (see FIG. 14).

The third parallelizing element 163 parallelizes the red light LR emitted from the third light guide element 43 along the D1 direction, similarly to the first parallelizing element 161 and the second parallelizing element 162.

The red light modulation device 106 has a third incident side polarization element 173, the third light modulation element 183, and a third emission side polarization element 177. The red light modulation device 106 is provided on the optical path of the red light LR emitted from the third parallelizing element 163.

The third incident side polarization element 173 emits predetermined polarized light out of the red light LR emitted from the third parallelizing element 163 toward the -D1 side along the D1 direction, similarly to the first incident side polarization element 171 and second incident side polarization element 172.

The third light modulation element 183 modulates the red light LR emitted from the third incident side polarization element 173, similarly to the first light modulation element 181 and the second light modulation element 182. The third light modulation element 183 generates red image light IR. The third light modulation element 183 emits the image light IR toward the -D1 side along the D1 direction.

The third emission side polarization element 177 emits predetermined polarized light out of the image light IR emitted from the third light modulation element 183 toward the -D1 side along the D1 direction, similarly to the first emission side polarization element 175 and the second emission side polarization element 176.

The light combining element 200 is disposed in a region where the optical path of the blue image light IB, the optical path of the green image light IG, and the optical path of the red image light IR intersect with each other. The light combining element 200 combines the image light IB, IG, and IR emitted from the first emission side polarization element 175, the second emission side polarization element 176, and the third emission side polarization element 177 with one another and emits image light IM thus generated toward the +D2 side along the D2 direction.

The projection optical system 250 is disposed in the optical path of the image light IM emitted from the light combining element 200. The projection optical system 250 projects the image on the screen SCR, and enlarges and displays the image input to the first light modulation element 181, the second light modulation element 182, and the third light modulation element 183 on the screen SCR.

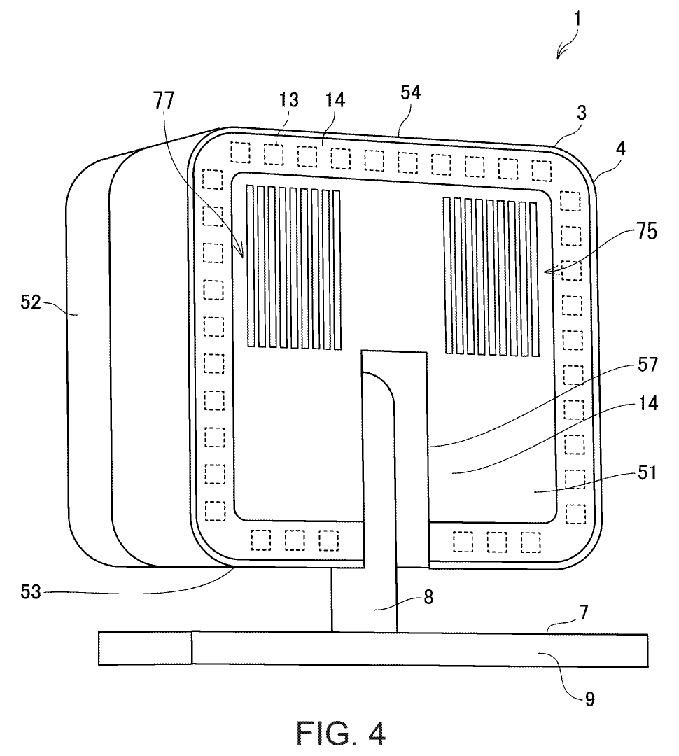

FIG. 4 is a perspective view illustrated a state in which the projector main body 3 is rotated.

The projector main body 3 includes a swing mechanism that rotates the projector main body 3 relative to the leg section 7.

The projector main body 3 is displaceable from the state illustrated in FIG. 2 to the state illustrated in FIG. 4 by the swing mechanism (not shown). The position of the displacement of the projector main body 3 by the swing mechanism is desirably two or more positions, and it may be smoothly displaced or may be displaced in a plurality of stages. The displacement may be realized by any one of horizontal rotation, vertical rotation, and three dimensional rotation. The swing mechanism is an example of a "rotation mechanism".

As illustrated in FIGS. 2 and 4, the leg section 7 includes a substantially rectangular shape base 9 and a cylindrical shape support pipe 8 extending upward from the center of the base 9.

A first end section 8a of the support pipe 8 is connected to the projector main body 3, and a second end section 8b is connected to the base 9.

The first end section 8a along a lengthwise axis of the support pipe 8 is inserted into a notch 14, which has a lengthwise axis 57 and which is opened in a bottom surface 51 of the projector main body 3, and is coupled to the bottom surface 51 side of the projector main body 3 via the swing mechanism. A surface where the notch 14 is present is one surface from which the illumination light from a plurality of LEDs 13 is emitted. The "one surface" of the projector main body 3 is a "first surface", that is, the bottom surface 51 of the projector main body 3.

The projector main body 3 is swung in the direction along the lengthwise axis 57 of the notch 14 by the swing mechanism.

The number of the support pipes 8 is not limited to one, and may be two or three. The support pipe 8 may be bent or branched in the middle. The cross section of the support pipe 8 may have various shapes such as a circular shape and a rectangular shape, and the leg section 7 may have, for example, a plate shape.

The shape of the base 9 is not particularly limited, and may be various shapes such as a disc shape. The leg section 7 may be configured only by the support pipe 8 without including the base 9.

### 2. Illumination system

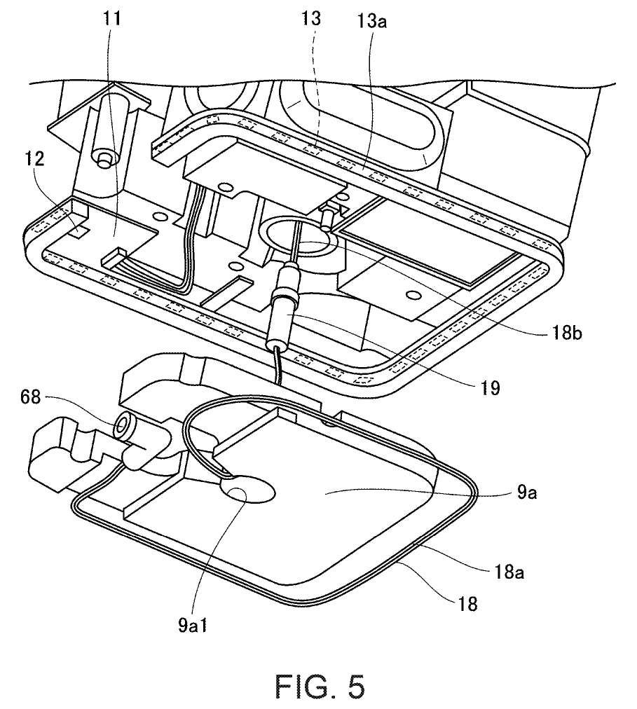

FIG. 5 is a perspective view illustrating a lower portion of the projector 1, and is a diagram in which the housing 4, the cover 21, and a part of the leg section 7 of the projector 1 are omitted.

As shown in FIG. 5, a substantially C-shaped illumination board 11 is disposed on the bottom surface 51 of the housing 4 so as to surround the leg section 7.

As shown in FIGS. 2 and 4, the illumination board 11 is disposed along the contour of the bottom surface 51. The plurality of LEDs 13 are mounted on the illumination board 11. The plurality of LEDs 13 are covered by an LED cover 13a made of a box-shaped transparent member. The illumination board 11 is provided with an LED driver 12. The plurality of LEDs 13 are controlled by the LED driver 12. The LED driver 12 is an example of a "driver element". Each of the plurality of LEDs 13 is an example of a "second light source." The light from the plurality of LEDs 13 may softly illuminate the periphery of the side table, like a lamp placed on the side table of the bed. Since the projector 1 also functions as an ambient light in this way, the convenience and the effect of the presentation can be improved.

The plurality of LEDs 13 are arranged along the contour of the bottom surface 51, but is interrupted by the opening of the notch 14 formed in the bottom surface 51, so that they are arranged in a substantially C-shape. The shape is not limited to the substantially C-shape, and although not illustrated in the drawings, the plurality of LEDs 13 may extend continuously along the entire periphery of an edge section of the notch 14 and be arranged in a ring shape. Note that it is desirable that at least two of the LEDs 13 among the LEDs 13 are arranged along the contour of the bottom surface 51, and some of the LEDs 13 may be included that are not arranged along the contour. The LEDs 13 may be disposed on the outer peripheral portion of the support pipe 8, or may be disposed on both the bottom surface 51 and the support pipe 8.

The illumination light from the plurality of LEDs 13 are emitted from an emission surface of the bottom surface 51 of the housing 4. The emission surface may be formed at a position recessed from the bottom surface 51, may be formed to be flush with the bottom surface 51, or may protrude from the bottom surface 51 to be formed in a convex shape.

For example, when the emission surface is formed at a recessed position, the plurality of LEDs 13 are not exposed from the bottom surface 51, and thus, the LEDs 13 are protected.

The emission surface in the present embodiment refers to a surface of the LED cover 13a from which light from the LED 13 is emitted.

The emission surface may be flush with the bottom surface 51 or may protrude from the bottom surface 51. When it is disposed flush with the bottom surface 51 of the housing 4, the aesthetic appearance is improved, and damage to the LED 13 is suppressed. In a case where the light source is projected from the bottom surface 51, it is possible to softly illuminate the periphery of the side table more effectively. The plurality of LEDs 13 may be configured to change brightness according to use environments.

The plurality of LEDs 13 are arranged at equal intervals. The distances between two adjacent LEDs 13 among the plurality of LEDs 13 are equal to or larger than the 5 mm and equal to or less than the 30 mm. The distance is a distance in a plan view, and is a distance between the centers of two adjacent LEDs 13. If the distance is less than the 5 mm, there is a risk of thermal influence between the LED 13, and the difficulty of mounting the LED 13 increases. When the distance exceeds the 30 mm, the expressiveness of the presentation of the LED 13 is reduced, and the shadow between the adjacent LEDs 13 becomes more noticeable.

The number of the plurality of LEDs 13 to be mounted is 10 pieces or more and 100 pieces or less, and desirably 20 pieces or more and 50 pieces or less. If there are fewer than 24 pieces, the effect is felt as a lonely impression. When the number of mounted is 24 pieces, the distance is 24 mm.

The number of mounts in LEDs 13 is 36 pieces, and the mounting distance is 16 mm. However, a single LED 13 may be added between the LEDs 13. In this case, the mounting distance of the LEDs 13 is 8 mm. If two are added, the mounting distance will be 5 mm. In this case, the difficulty of mounting is slightly increased, and the arrangement is difficult.

The plurality of LEDs 13 may include the first light emitter that emit light of a first color and the second light emitter that emit light of a second color different from the first color.

The first light emitter is a light emitting diode element that emits light of the first color, and the second light emitter is a light emitting diode element that emits light of the second color.

That is, since each of the "second light sources" includes a light emitting diode element, the degree of freedom of the color and the arrangement of the elements is increased, the degree of freedom of the design can be increased, and the effect of the presentation and the convenience are improved.

The light from the plurality of LEDs 13 may include a plurality of colors. For example, the color may be changed or the light may be blinked according to the state, the setting, or the like at the time of activation of the projector 1. Since the LED 13 is positioned on the bottom surface 51, it serves as indirect ambient light that softly illuminates the entire space, and does not cause glare when projecting with the projector 1.

The LED 13 may be an LED chip or an organic EL panel. The plurality of second light sources may emit light to the outside, and the second light sources may be attached at any position.

For example, the second light source may be provided in the projector main body 3 or may be attached to the surface of the projector main body 3.

### 3. Image and direction of illumination light

The projector main body 3 includes the bottom surface 51 through which illumination light from the plurality of LEDs 13 is emitted, and the front surface 54 through which image light from the projection lens 16 is emitted, as illustrated in FIG. 1.

The image light and the illumination light are emitted from different surfaces of the projector main body 3. In the present embodiment, the image light is emitted from the front surface, and the illumination light is emitted from the bottom surface. An angle θ formed by the front surface 54 and the bottom surface 51 is 90°. That is, the angle θ formed by the direction in which the image light from the projector main body 3 is emitted and the direction in which the illumination light from the plurality of LEDs 13 is emitted is 90°. Therefore, it is possible to prevent the projected image from becoming difficult to see due to the illumination light.

In the above description, the projector main body 3 has a rectangular box shape, but in the case where the projector main body 3 has a cylindrical shape, although not shown, the projection lens 16 can be disposed on the front surface side of the projector main body 3, and a plurality of LEDs 13 can be arranged on the back surface side.

In this case, it is desirable that an angle θ formed by the direction in which the image light is emitted and the direction in which the illumination light is emitted is 90° or more.

Here, the direction in which the image light is emitted refers to a direction in which the light travels along the optical axis of the image light.

The direction in which the illumination light is emitted refers to either the direction in which the light travels along the central axis of the entire light, when the entire plurality of LEDs 13 is considered as one illumination light, or the direction in which the light travels along the optical axis of each LED 13.

### 4. Touch sensor

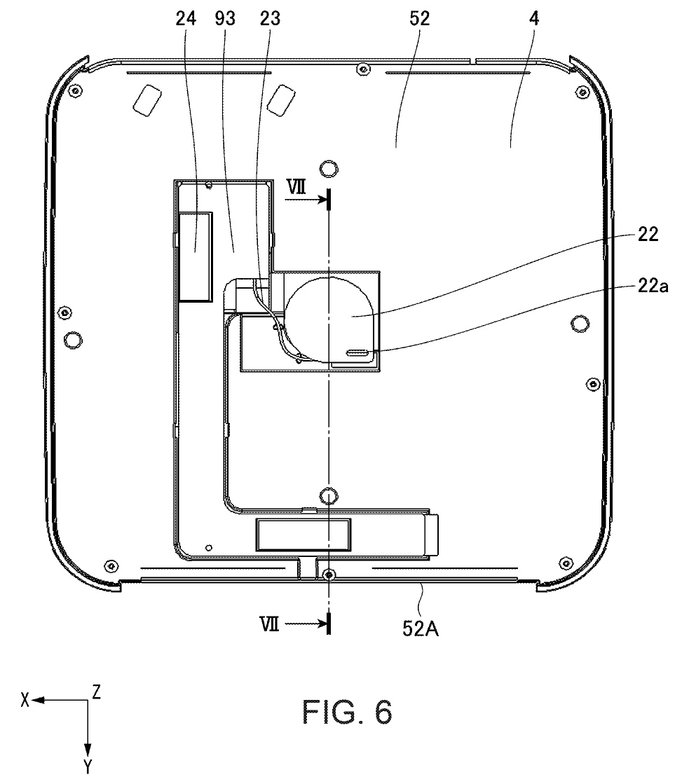

FIG. 6 is a top view illustrating the top surface 52 of the housing 4 with the cover 21 removed.

As shown in FIG. 1, the housing 4 includes the top surface 52. The top surface 52 is opposing the bottom surface 51 from which the illumination light of the LED 13 is emitted. As illustrated in FIG. 6A, a touch sensor (sensor) 22, which detects the user's contact with the projector main body 3, is disposed between the top surface 52 and the cover 21.

The touch sensor 22 may be a button or a sensor. The cover 21 is provided on the touch sensor 22, and as illustrated in FIG. 6, the touch sensor 22 is disposed on a back surface of the cover 21. Since the touch sensor 22 is hidden by the cover 21, the appearance of the projector 1 can be improved. The touch sensor 22 is an example of a "sensor". Note that when the position of the projector main body 3 is displaced by the swing mechanism, it is desirable that the touch sensor 22 is not disposed on the same surface as the leg section 7.

In the present embodiment, the touch sensor 22 is a copper foil tape. A sensor wiring 23 is attached to an end portion of the touch sensor 22 by soldering. The sensor wiring 23 is connected to a microcontroller 24. An oval shaped opening 22a is formed near a joint section of the touch sensor 22 with the sensor wiring 23. By this, the excessive solder is removed from the opening 22a at the time of soldering. Therefore, the solder does not contaminate the touch sensor 22. By this, prevents the solder from affecting the touch sensor 22, thereby preventing a decrease in sensitivity. The solder is an example of a "conductive bonding material".

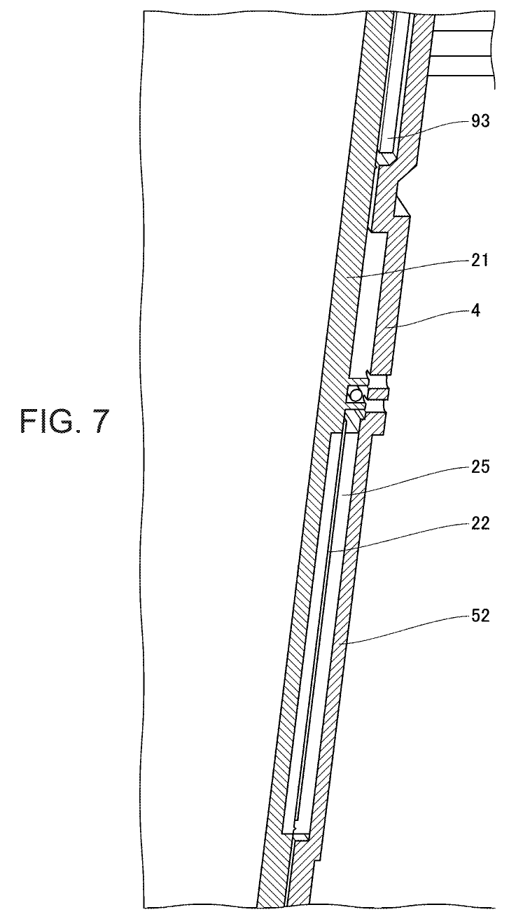

FIG. 7 is a cross-sectional view taken along line VII-VII in FIG. 6.

A spacer 25 is disposed below the touch sensor 22 and, in a state where the cover 21 is attached to the top surface 52, the touch sensor 22 and the spacer 25 are sandwiched between the top surface 52 and the cover 21 as illustrated in FIG. 7. The touch sensor 22 is in a state of being pressed against the back surface of the cover 21 by the spacer 25. Therefore, air is less likely to enter between the touch sensor 22 and the cover 21, and it is possible to prevent the sensitivity of the touch sensor 22 from being lowered by air.

Since the touch sensor 22 is hidden by the cover 21, the aesthetic appearance of the projector 1 is improved. Since the touch sensor 22 is used, the ambient light can be turned on and off without using a remote controller for the ambient light.

When the touch sensor 22 is repeatedly tapped, the ambient light may be turned on and off, the brightness may be decreased, the color of the ambient light may be changed, or the like.

A control section that controls the plurality of LEDs 13 is not limited to the touch sensor 22. For example, another switch, a button, a touch panel, or the like may be used. The control section for turning on the plurality of LEDs 13 is desirably a sensor or the like that is attached to the projector main body 3 and that can be operated by touching the projector main body 3 manually.

As illustrated in FIG. 2, a power button 65 is disposed on a back surface 53 of the projector main body 3. The power button 65 is a button for switching the operation of the projector main body 3 between on and off.

As illustrated in FIG. 2, an indicator 27 that emits light to the outside of the projector main body 3 is disposed on the back surface 53 of the projector main body 3. The indicator 27 is an LED indicator using a fourth light source 28 (see FIG. 14) different from the LED 13, and notifies the state of the optical configuration of the projector main body 3.

Since the indicator 27 is positioned on the opposite side than the projection lens 16, there is an advantage that the user does not need to directly look at the projection light when viewing the indicator 27.

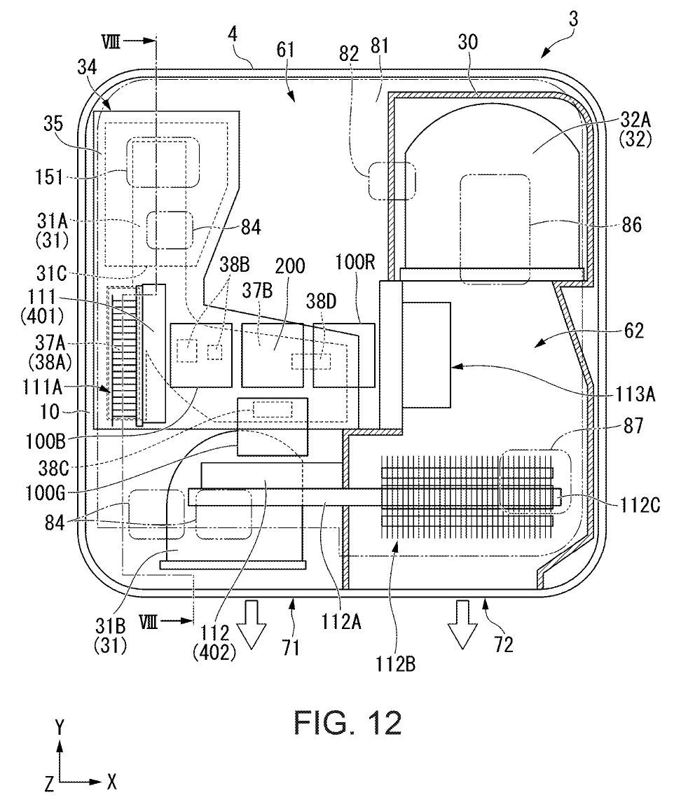

A first air outlet port 71, a second air outlet port 72, and an opening 73 for a video terminal are disposed on the back surface 53 of the projector main body 3. A first air intake port 75 and a second air intake port 77 are disposed side by side on the left and right sides on the bottom surface 51 of the projector main body 3. The side surfaces of the projector main body 3 include the back surface 53 and the front surface 54 other than the bottom surface 51 and the top surface 52. By driving a first cooling device 31 and a second cooling device 32 (see FIG. 12) (to be described later), air is sucked into the projector 1 through the first air intake port 75 and the second air intake port 77. The air thus sucked cools the heat generating devices inside the projector 1 and is discharged from the first air outlet port 71 and the second air outlet port 72.

The position of the first air outlet port 71 and the second air outlet port 72 are not limited to the back surface 53, and may be the bottom surface 51, the top surface 52, or the side surface of the projector main body 3. Note that it is desirable that the first air outlet port 71 and the second air outlet port 72, and the first air intake port 75 and the second air intake port 77 are not disposed on the same surface so as not to suck the exhausted air again.

It is desirable that the first air outlet port 71 and the second air outlet port 72, and the first air intake port 75 and the second air intake port 77 are not disposed on the same surface as the touch sensor 22. By this, the dust guided along the flow of air can be suppressed from adhering to the touch sensor 22.

The opening 73 for the video terminal illustrated in FIG. 2 is an insertion port of a connection terminal for supplying a video from an external device to the projector main body 3. In the present embodiment, the opening 73 for the video terminal is an opening for a Universal Serial Bus (USB) terminal and a High-Definition Multimedia Interface (registered trademark: HDMI) terminal. Therefore, by connecting the external device and the projector main body 3 to each other via the USB terminal or the HDMI (registered trademark) terminal, the projector main body 3 can project video information from the external device as image light. Note that it is desirable that the opening 73 for the video terminal is not disposed on the same surface as the touch sensor 22.

### 5. Wiring system of board

As illustrated in FIG. 2, the base 9 has a base case 9a with an open lower surface, and a base cover 9b that covers the lower surface of the base case 9a.

As illustrated in FIG. 5, a round hole 9a1 penetrating in the vertical direction is formed in the base case 9a. The second end section 8b of the support pipe 8 is supported by the round hole 9a1.

As illustrated in FIG. 2, the base 9 includes an AC adapter terminal 68 connected to a power supply. The AC adapter terminal 68 is disposed on the side surface of the base case 9a. An AC adapter 20 (see FIG. 14) is connected to the AC adapter terminal 68. The AC adapter terminal 68 is an example of a "power supply terminal". The AC adapter 20 is an example of a "power supply adapter".

Since the AC adapter terminal 68 is disposed not on the projector main body 3 but on the base 9, a power supply wiring 18 connected to the AC adapter terminal 68 does not interfere with the swinging of the projector main body 3.

As illustrated in FIG. 5, the power supply wiring 18 extends from the AC adapter terminal 68. The power supply wiring 18 is disposed along the outer periphery on the lower surface of the base case 9a, passes through the inside of the support pipe 8 from the round hole 9a1, and is connected to a power supply circuit 83 (see FIG. 14) of a main board 81 (to be described later). In this manner, the power supply wiring 18 is provided with play, and thereby, workability at the time of assembly is facilitated, and damage to the power supply wiring 18 when the projector main body 3 is rotated is suppressed.

The power supply wiring 18 is configured by a first wiring 18a extending from the AC adapter terminal 68 and a second wiring 18b extending from the main board 81. The first wiring 18a and the second wiring 18b are connected by a connector 19 in the support pipe 8. Since the connector 19 is not accommodated inside the projector main body 3, the workability at the time of assembly or the like is improved.

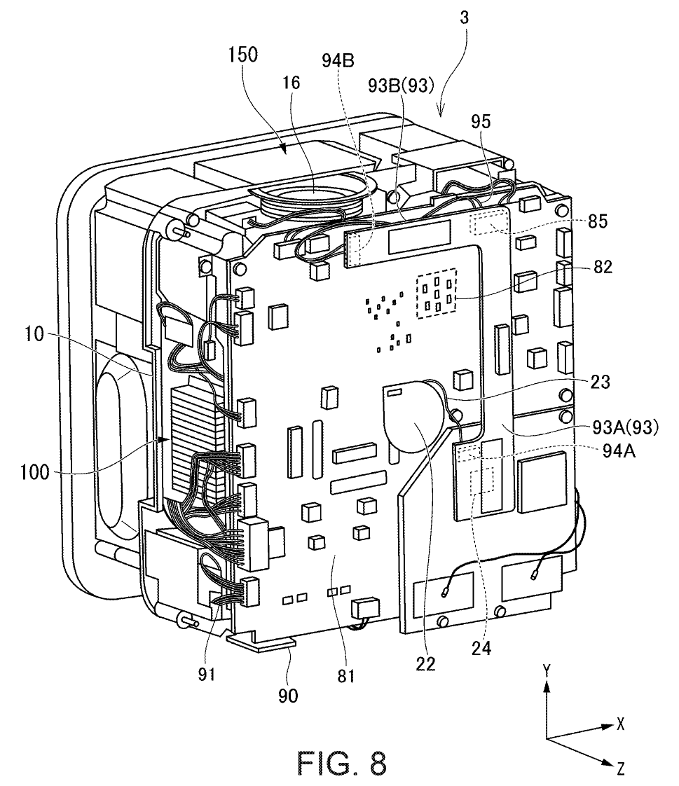

FIG. 8 is a diagram illustrating the projector main body 3 from which the housing 4 and the cover 21 are removed. The projector main body 3 includes the main board 81, a connection board 93, and an auxiliary board 90. The main board 81 of the projector 1 is disposed below the housing 4 and on the top surface 52 of the projector main body 3.

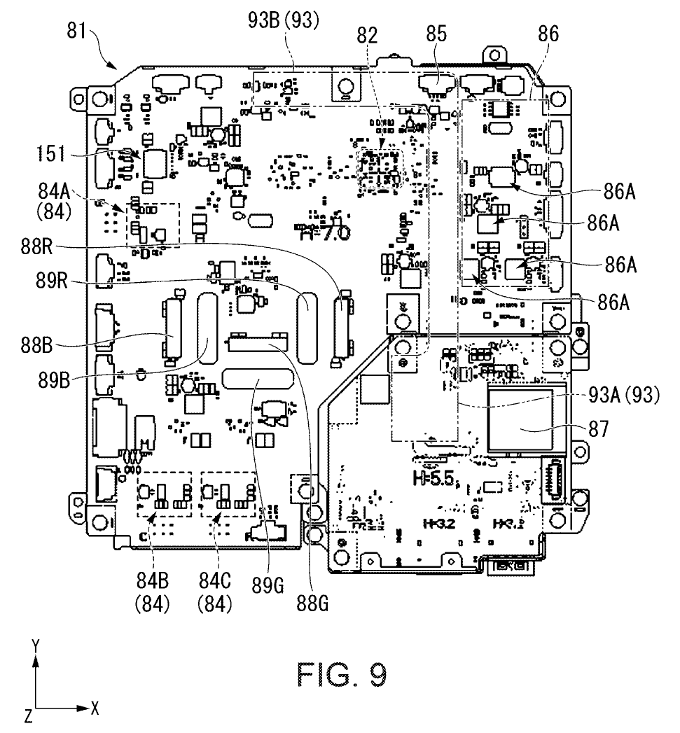

FIG. 9 is a plan view of the main board 81 as viewed from above in the opposing direction that opposes the main board 81. As illustrated in FIGS. 8 and 9 , the main board 81 is formed in a substantially rectangular shape. The main board 81 has a System on a Chip (SoC) 82, a driver element 84 that controls the light source 400, a connector 85, a DC/DC circuit 86 for voltage transformation having a plurality of coils 86A, a communication module 87, and an amplifier element 151. The SoC 82 corresponds to an example of an “integrated circuit element".

The driver element 84 has a first driver element 84A that drives the first light source 401, a second driver element 84B that drives the second light source 402, and a third driver element 84C that drives the third light source 403. The amplifier element 151 transmits the amplified signal to the acoustic device 150.

The connector 85 is electrically connected to the SoC 82. The connector 85 is disposed on an outer peripheral portion of the upper surface of the main board 81. The connector 85 is disposed at a position closer to the outer peripheral portion than the touch sensor 22 disposed inside the outer peripheral portion of the main board 81 in plan view (hereinafter simply referred to as "plan view") of the projector main body 3 viewed from above.

Assuming that the vertical direction of the projector main body 3 is a Z direction, a direction in which an outer peripheral portion of the main board 81 on which the connector 85 is disposed extends in plan view is an X direction, and a direction perpendicular to both the Z direction and the X direction is a Y direction. The +Z side is the upper side, and the -Z side is the lower side. The Z direction corresponds to a opposing direction opposing the main board 81. The Y direction corresponds to a first direction. The +Y side corresponds to one side in the first direction. The -Y side corresponds to the other side in the first direction.

The connector 85 is disposed between the SoC 82 and the DC/DC circuit 86 in the X direction. The connector 85, the DC/DC circuit 86, the communication module 87, and the amplifier element 151 are disposed on the surface on the +Z side of the main board 81. The SoC 82 and the driver element 84 are disposed on the surface on the -Z side of the main board 81.

The connection board 93 is formed of, for example, a non-flexible hard material (rigid board). Examples of the hard material include a board obtained by impregnating paper with a phenol resin, a board obtained by impregnating paper with an epoxy resin, a glass composite board, and a glass epoxy board.

As illustrated in FIG. 7, the connection board 93 is disposed between the top surface 52 of the housing 4 and the cover 21. The connection board 93 is a board on which the microcontroller 24 that controls the touch sensor 22 is disposed on the -Z side surface. The connection board 93 is separated from the main board 81 in order to reduce the footprint, and is disposed between the housing 4 and the cover 21 where a space can be secured.

The connection board 93 includes a first portion 93A and a second portion 93B. The first portion 93A extends in the Y-direction. The position of the first portion 93A in the X direction is a position overlapping the connector 85 in plan view. The first portion 93A has a connection connector 94A on a surface opposing the main board 81 on the -Y side, which is one end side. The connection connector 94A is electrically connected to the microcontroller 24. The connection connector 94A is connected to the sensor wiring 23. The microcontroller 24 is electrically connected to the touch sensor 22 via the sensor wiring 23.

The first portion 93A linearly extends from the -Y side to the +Y side toward the connector 85. The first portion 93A is disposed separated from the electromagnetic interference object described above in plan view. The first portion 93A is disposed at a position and with a size so as to not overlap the electromagnetic interference object in plan view. As an example, the first portion 93A is disposed at a position and with a size so as to not overlap the SoC 82 described above, the DC/DC circuit 86, and the communication module 87 in plan view. The first portion 93A may extend in a zigzag shape or a curved shape in a path that circumvents the electromagnetic interference object described above in plan view, in addition to a straight line shape, as long as the first portion 93A does not overlap the electromagnetic interference object in plan view.

Since the connection board 93 is a rigid board, bending is suppressed, and thus, it is possible to suppress deterioration of the EMI characteristics due to contact with the electromagnetic interference object. Since the first portion 93A is disposed separated from the electromagnetic interference object and does not overlap the electromagnetic interference object in plan view, it is possible to suppress the occurrence of noise due to deterioration of the EMI characteristics caused by electromagnetic interference with the electromagnetic interference object.

The second portion 93B extends from a tip end of the first portion 93A in a direction separated from the connector 85 along the outer peripheral portion of the main board 81 in plan view. The connector 85 opposes the intersection of the first portion 93A and the second portion 93B in the Z direction. The second portion 93B linearly extends from the tip end of the first portion 93A toward the -X side. The second portion 93B is disposed separated from the electromagnetic interference object described above in plan view. The second portion 93B is disposed at a position and with a size so as not to overlap the electromagnetic interference object in plan view. As an example, the second portion 93B is disposed at a position and with a size so as not to overlap the SoC 82 in plan view. The second portion 93B may extend from the tip end of the first portion 93A in a zigzag shape or curved shape path that circumvents the electromagnetic interference object described above in plan view, in addition to extending linearly, as long as the second portion 93B does not overlap the electromagnetic interference object in plan view.

Since the second portion 93B is disposed separated from the electromagnetic interference object and does not overlap the electromagnetic interference object in plan view, it is possible to suppress the occurrence of noise due to deterioration of the EMI characteristics caused by electromagnetic interference with the electromagnetic interference object.

The second portion 93B has a second connector 94B at a tip end on the -X side. The second connector 94B is electrically connected to the microcontroller 24. The second connector 94B is connected to a connection cable 95. The connection cable 95 is drawn out from the second connector 94B to the -X side, is then drawn around to the +X side, and is connected to the connector 85 across the top surface 52 in the Z direction via a notch 52A formed at an end edge of the top surface 52 on the +Y side as illustrated in FIG. 6. Therefore, the microcontroller 24 is electrically connected to the SoC 82 via the connection cable 95 and the connector 85. The SoC 82 inputs a detection result of the touch sensor 22 via the microcontroller 24 and the connection cable 95.

Since the distance between the connection board 93 and the main board 81 in the Z direction is several cm, for example, in a case where the second connector 94B is provided at a tip end of the first portion 93A on the +Y side without providing the second portion 93B in the connection board 93, the distance between the connector 85 and the second connector 94B is short. In this case, considering the lengths of the terminals at both ends of the connection cable 95, the movable range of the connection cable 95 becomes short, and the work of attaching the connection cable 95 to the connector 85 and the second connector 94B becomes difficult.

In the present embodiment, the connection board 93 has the second portion 93B, and the second connector 94B is intentionally provided at a position separated from the connector 85, and thus, the distance between the connector 85 and the second connector 94B and the length of the connection cable 95 are increased, and the movable range of the connection cable 95 is increased, and thus, the work of mounting the connection cable 95 on the connector 85 and the second connector 94B is facilitated.

Since the connection cable 95 is connected to the connector 85 across the top surface 52 in the Z direction via the notch 52A on the +Y side, for example, compared to a case where the connection cable 95 is inserted into a hole section formed inside the end edge of the top surface 52 and connected to the connector 85, the work of connecting the connection cable 95 to the connector 85 from the +Y side is facilitated.

The main board 81 has a first light source connector 88B, a second light source connector 88G, and a third light source connector 88R electrically connected to the first light source 401, the second light source 402, and the third light source 403, respectively, and an opening section 89B, an opening section 89G, and an opening section 89R through which light source wirings (not shown) electrically connected to the first light source connector 88B, the second light source connector 88G, and the third light source connector 88R, respectively, are inserted. The connection board 93 is disposed apart from the opening section 89B, the opening section 89G, and the opening section 89R in plan view, and the connection board 93 is disposed separated from the opening section 89B, the opening section 89G, and the opening section 89R in plan view, and thus, it is possible to suppress an adverse effect of static charge due to the light source wiring.

As illustrated in FIG. 8, the auxiliary board 90 on which the fourth light source 28 is mounted is disposed on the back surface 53 of the projector main body 3 and substantially perpendicular to the main board 81. The auxiliary board 90 is connected to the main board 81 by an auxiliary wiring 91.

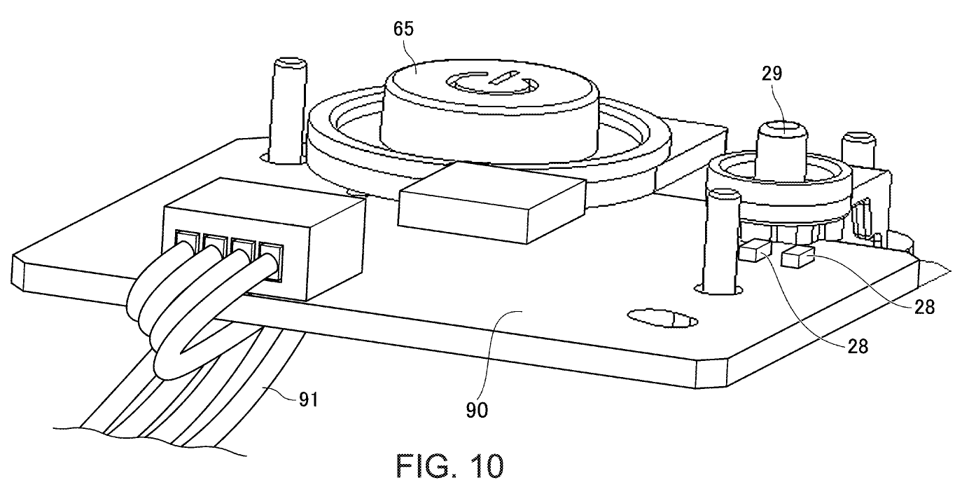

FIG. 10 is a perspective view of the auxiliary board 90.

The power button 65 and the fourth light source 28 are mounted on the auxiliary board 90. In the present embodiment, the fourth light source 28 is an LED. The fourth light source 28 is disposed so that a lens 29 covers it in the direction of irradiation. A part of the outer end of the lens 29 is exposed to the exterior of the housing 4, and light is emitted to the outside of the projector main body 3 via the lens 29 by the lighting of the fourth light source 28, and functions as the indicator 27 as illustrated in FIG. 2. In the present embodiment, two fourth light sources 28 are mounted, and the emission colors thereof are different from each other. The lighting pattern of the fourth light source 28 allows the user to recognize the state of the projector 1.

In the present embodiment, the microcontroller 24 performs only the detection of the touch sensor 22, receives output information of the touch sensor 22 via the sensor wiring 23 connected to the touch sensor 22, and performs processing according to the output. Since the microcontroller 24 performs only the detection of the touch sensor 22, it is possible to prevent the detection from being missed. The sensor wiring 23 is an example of "wiring for transmitting an output of the touch sensor".

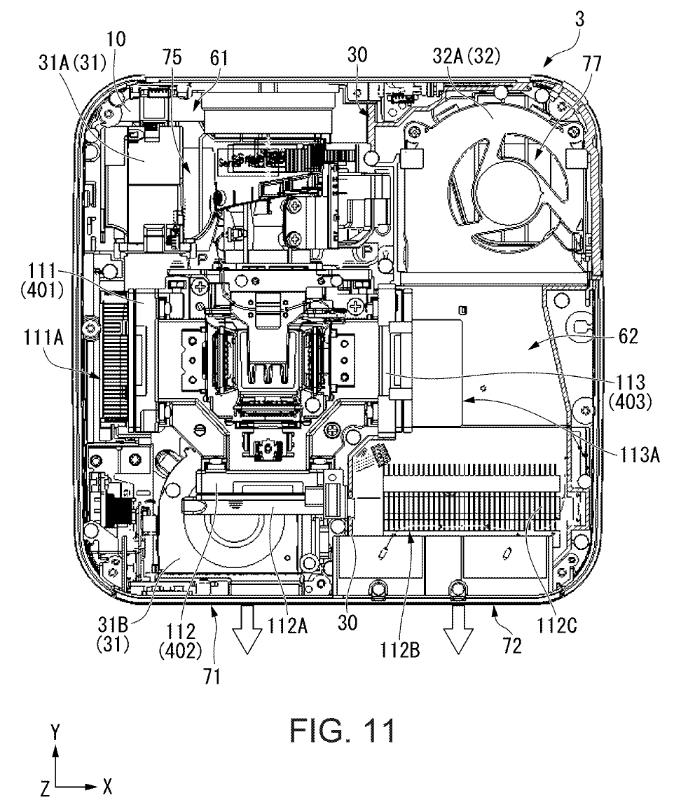

FIG. 11 is a plan view illustrating the projector main body 3 from which the cover 21 and the main board 81 are removed. The projector main body 3 includes a partition section 30, a first cooling device 31, and a second cooling device 32. The partition section 30 partitions an internal space of the housing 4 into a first cooling flow path 61 positioned on the -X side and a second cooling flow path 62 positioned on the +X side. The first cooling flow path 61 and the second cooling flow path 62 each extend in the Y direction. The first cooling flow path 61 and the second cooling flow path 62 are formed on the upper side of a support board 10 (see FIG. 8) that supports the optical device 100 from the lower side.

FIG. 12 is a schematic plan view of cooling elements in the first cooling flow path 61 and the second cooling flow path 62. In FIG. 12, the main board 81 and the elements mounted on the main board 81 are indicated by two-dot chain line. In FIG. 12, the partition section 30 is illustrated with hatching.

The partition section 30 prevents the air blown from a first fan 31A to the first cooling flow path 61 from flowing into the second cooling flow path 62. The partition section 30 prevents the air blown from the first fan 31A to the first cooling flow path 61 from flowing into the second cooling flow path 62 at least on the -Y side of an air blowing port through which a third fan 32A blows air into the second cooling flow path 62. In the partition section 30, a region in which the third fan 32A opposes the second air intake port 77 and air is sucked from the second air intake port 77 may be open on the +Y side of the air blowing port of the third fan 32A.

The partition section 30 is formed of a substantially cylindrical shaped duct extending in the Y direction. The partition section 30 forms a second cooling flow path 62 in the duct. The duct opens to the -Z side at the end portion on the +Y side. The opening of the duct opposes the second air intake port 77. The duct covers the internal space of the housing 4 on the -Y side of the air blowing port of the third fan 32A that blows air to the second cooling flow path 62, thereby forming the second cooling flow path 62 separated from the first cooling flow path 61. In the internal space of the housing 4, a region that is not surrounded by the duct on the upper side of the support board 10 is a first cooling flow path 61.

The first cooling device 31 cools the first cooling flow path 61. The first cooling device 31 has the first fan 31A disposed on the +Y side of the first cooling flow path 61 and a second fan 31B disposed on the -Y side of the first cooling flow path 61. The second fan 31B is disposed to oppose the +Y side of the first air outlet port 71. The first fan 31A is, for example, a centrifugal fan that rotates around a rotation axis extending in the X direction. The first fan 31A blows the air sucked through the first air intake port 75 to the first cooling flow path 61. The second fan 31B is, for example, a centrifugal fan that rotates around a rotation axis extending in the Z direction. The second fan 31B blows the sucked air to the -Y side and exhausts the air from the first air outlet port 71.

The second cooling device 32 cools the second cooling flow path 62. The second cooling device 32 has a third fan 32A disposed on the +Y side of the second cooling flow path 62. The third fan 32A is, for example, a centrifugal fan that rotates around a rotation axis extending in the Z direction. The third fan 32A blows the air sucked from the second air intake port 77 through the opening of the duct to the -Y side and exhausts the air from the second air outlet port 72. The intake air volume of the third fan 32A is larger than the intake air volume of the first fan 31A.

The first light source 401, the second light source 402, the third light source 403, and the main board 81 are disposed in the first cooling flow path 61. That is, the SoC 82, the driver element 84, the DC/DC circuit 86, and the communication module 87, which are disposed on the main board 81 and generate a large amount of heat, are disposed in the first cooling flow path 61.

The first board 111 supporting the first light emitter 121 of the first light source 401 is provided with first cooling fins 111A. The first cooling fins 111A are made of a plurality of metallic plate members that are parallel to an XZ plane, that extend in the Z direction, and that are provided with gaps therebetween in the Y direction. The first cooling fins 111A are disposed in the first cooling flow path 61.

The second board 112 supporting the second light emitter 122 of the second light source 402 is provided with a heat pipe 112A and second cooling fins 112B. The heat pipe 112A has a shaft shape extending in the X direction. The heat pipe 112A is provided in contact with the -Y side end portion of the second board 112 from the -Y side via grease. The heat pipe 112A extends from the first cooling flow path 61 to the second cooling flow path 62 through the partition section 30. The second cooling fins 112B are made of a plurality of metallic plate members that are parallel to a YZ plane, that extend in the Z direction, and that are provided with gaps therebetween in the X direction. The plurality of second cooling fins 112B are connected by a cylinder section 112C extending in the X direction. The second cooling fins 112B are disposed in the second cooling flow path 62. The heat pipe 112A is inserted into the cylinder section 112C from the -X side and in contact with it. That is, the heat pipe 112A is disposed across the first cooling flow path 61 and the second cooling flow path 62, and is in contact with the second light source 402 and the second cooling fins 112B.

The +Y side end portions of the second cooling fins 112B are positioned on the +Y side of the -Y side end portion of the second board 112 as viewed from the height direction of the housing 4. Since the end portions on the +Y side of the second cooling fins 112B are positioned on the +Y side of the -Y side end portion of the second board 112, the second cooling fins 112B can be disposed on the +Y side compared to the case where the second cooling fins 112B are disposed in contact with the -Y side of the second board 112, whereby the projector main body 3 can be reduced in size in the Y direction.

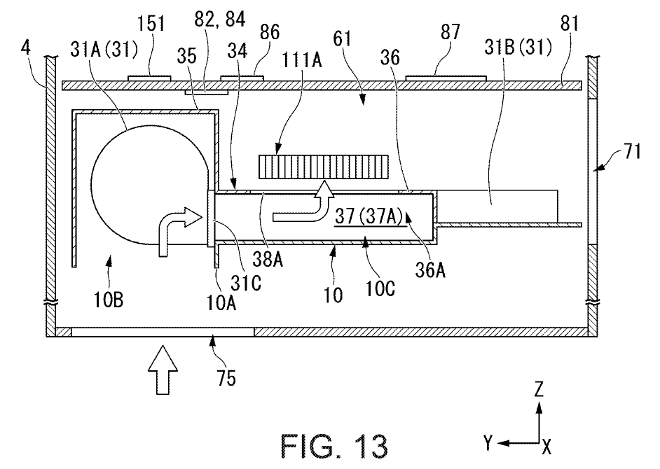

FIG. 13 is a cross-sectional view taken along line VIII-VIII in FIG. 12.

As illustrated in FIG. 13, in the first cooling flow path 61, a branch duct 34 is provided on the air blowing port 31C of the first fan 31A. The branch duct 34 is fixed to the support board 10 from above. The branch duct 34 has a fan case 35 and a flow path forming section 36. The fan case 35 has a cylindrical shape extending in the Z direction, and has a closed upper side and an open lower side. The fan case 35 accommodates the first fan 31A. The fan case 35 forms an opening 10B between the fan case 35 and a wall section 10A, which extends downward from the +Y side end portion of the support board 10. The opening 10B opposes the first air intake port 75 in the Z direction.

The flow path forming section 36 has a recess section 36A that is recessed upward and opens downward. The support board 10 has a recess section 10C extending from the air blowing port 31C to the -Y side. The recess section 10C is recessed downward and opens upward. The recess section 36A and the recess section 10C oppose each other in the Z direction and form a plurality of branch paths 37 extending to the -Y side. As shown in FIG. 12, the branch paths 37 include a first branch path 37A and a second branch path 37B. Although an example in which the number of branch paths 37 is two is illustrated, the number may be three or more.

The branch paths 37 branch the air from the air blowing port 31C and guide the air to a predetermined position of the first cooling flow path 61. The branch paths 37 have opening sections that open at predetermined positions of the first cooling flow path 61. The first branch path 37A has an opening section 38A that extends to a lower side of the first cooling fins 111A at a predetermined position and opposes the first cooling fins 111A in the Z direction.

The second branch path 37B extends to, as an example, a position overlapping the first image forming module 100B, the second image forming module 100G, the third image forming module 100R, and the light combining element 200 among the optical device 100 as viewed from the upper side. The second branch path 37B has opening sections 38B, 38C, and 38D that oppose, in the direction Z, the first image forming module 100B, the second image forming module 100G, the third image forming module 100R, and the light combining element 200. The opening section 38B is open at a position opposing the first image forming module 100B in the Z direction. The opening section 38C is open at a position opposing the second image forming module 100G in the Z direction. The opening section 38D is open at a position opposing the third image forming module 100R and the light combining element 200 in the direction Z.

Among the air sucked by the first fan 31A through the first air intake port 75 and blown to the branch paths 37, the air blown from the opening section 38A through the first branch path 37A passes through the first cooling fins 111A, cools the first cooling fins 111A by heat exchange, and is then blown upward to the first cooling flow path 61.

Among the air sucked by the first fan 31A through the first air intake port 75 and blown to the branch paths 37, the air blown from the opening section 38B via the second branch path 37B is blown upward toward the first image forming module 100B, cools the first image forming module 100B by heat exchange, and then is blown toward the main board 81. The air blown from the opening section 38C through the second branch path 37B is blown upward toward the second image forming module 100G, cools the second image forming module 100G by heat exchange, and then is blown toward the main board 81. The air blown from the opening section 38D through the second branch path 37B is blown upward toward the third image forming module 100R, cools the third image forming module 100R and the light combining element 200 by heat exchange, and is then blown toward the main board 81.

The air blown toward the main board 81 flows along the lower surface of the main board 81, thereby cooling the main board 81 including the SoC 82, the driver element 84, the DC/DC circuit 86, the communication module 87, and the amplifier element 151 by heat exchange. Therefore, the first light source 401, the second light source 402, the third light source 403, the SoC 82, the driver element 84, the DC/DC circuit 86, the communication module 87, and the amplifier element 151, which are disposed in the first cooling flow path 61, are cooled by heat exchange with air. By sending the air sucked by the first fan 31A to the branch paths 37 and sending the air sucked by the second fan 31B to the -Y side to be exhausted from the first air outlet port 71, a flow of air from the +Y side to the -Y side is generated in the first cooling flow path 61 as a whole, and the first light source 401, the second light source 402, the third light source 403, the SoC 82, the driver element 84, the communication module 87, and the amplifier element 151 are cooled by heat exchange with the air.

Here, since the SoC 82 and the amplifier element 151 are disposed at a position closer to the first fan 31A than to the second fan 31B as viewed from the upper side, heat exchange is with air having a smaller temperature rise than air on the downstream side (-Y side), which has a larger temperature rise as a whole due to heat exchange, and, by this, effective cooling is possible.

Third cooling fins 113A and the second cooling fins 112B described above are disposed in the second cooling flow path 62. The third cooling fins 113A are provided on the third board 113 that supports the third light emitter 123 of the third light source 403. The third cooling fins 113A are made of a plurality of metallic plate members that are parallel to an XY plane, that extend in the Y direction, and that are provided with gaps therebetween in the Z direction. The third cooling fins 113A are disposed at a position closer to the third fan 32A on the +Y side than the second cooling fins 112B.

The air sucked by the third fan 32A through the second air intake port 77 is blown to the -Y side of the second cooling flow path 62 through the opening of the duct of the partition section 30. The third cooling fins 113A and the second cooling fins 112B are sequentially cooled by heat exchange with the air blown into the second cooling flow path 62. The air whose temperature has been raised by the heat exchange is exhausted from the second air outlet port 72.

By cooling the third cooling fins 113A, the third light source 403 is cooled via the third board 113. The second cooling fins 112B are cooled and the heat pipe 112A is in contact with the second board 112 and the temperature thereof rises and, by this, the working fluid in of the heat pipe 112A evaporates on the side in contact with the second board 112 to become gas, and absorbs heat as latent heat and releases the heat to the second cooling fins 112B and returns to being liquid, so that the second light source 402 are cooled via the second board 112. That is, the second light source 402 is directly cooled by heat exchange with the air flowing through the first cooling flow path 61, and the second cooling fins 112B are indirectly cooled via the heat pipe 112A by heat exchange with the air flowing through the second cooling flow path 62.

In the present embodiment, the amount of heat released to the second cooling flow path 62 is larger than the amount of heat released to the first cooling flow path 61. Specifically, the amount of heat released from the third cooling fins 113A and the second cooling fins 112B in the second cooling flow path 62 is larger than the amount of heat released from the first light source 401, second light source 402, and third light source 403, the SoC 82, and the main board 81 including the driver element 84, the DC/DC circuit 86, the communication module 87, and the amplifier element 151 in the first cooling flow path 61.

In other words, the power consumption P (W) in the above described members, circuits, and elements correlates with the amount of heat generated and is obtained by multiplying the voltage V by the current I. Therefore, the sum of the power consumption P of the heat generation sources in the second cooling flow path 62 is larger than the sum of the power consumption P of the heat generation sources in the first cooling flow path 61.

In the present embodiment, the cooling capacity of the second cooling device 32 is higher than the cooling capacity of the first cooling device 31. The cooling capacity is correlated with, for example, the air volume, the static pressure, and the rotation speed. Therefore, by making the cooling capacity of the third fan 32A higher than the sum of the cooling capacity of the first fan 31A and the second fan 31B, it is possible to effectively cool the projector main body 3 having the plurality of light sources 400.

FIG. 14 is a block diagram illustrating the configuration of each of the boards 11, 81, 90, and 93. In FIG. 14, solid lines indicate signal input/output relationships and chain lines indicate electrical connection relationships. The main board 81 is connected to the illumination board 11, the auxiliary board 90, and the connection board 93. The SoC 82 disposed on the main board 81 is connected to the LED driver 12 and controls the LEDs 13 mounted on the illumination board 11 via the LED driver 12.

As described above, in the projector 1 according to the present embodiment, since the amount of heat released in the second cooling flow path 62 is larger than the amount of heat released in the first cooling flow path 61, and the cooling capacity of the second cooling device 32 is higher than the cooling capacity of the first cooling device 31, the projector main body 3 having the plurality of light sources 400 can be effectively cooled.

In the projector 1 according to the present embodiment, the first fan 31A with a small intake air volume is disposed in the first cooling flow path 61, which releases a small amount of heat, and a third fan 32A with a large intake air volume is disposed in the second cooling flow path 62, which emits a large amount of heat, making it possible to effectively cool the first cooling flow path 61 and the second cooling flow path 62 according to the amount of heat released.

In the projector 1 according to the present embodiment, the second light source 402, which emits green light, is directly cooled by heat exchange with the air flowing through the first cooling flow path 61, and the second cooling fins 112B are indirectly cooled via the heat pipe 112A by heat exchange with the air flowing through the second cooling flow path 62. Therefore, in the projector 1 according to the present embodiment, the second light source 402 of green, which is most sensitive to human eyes and has a large driving amount, can be cooled more effectively using both the first cooling device 31 and the second cooling device 32.

Further, in the projector 1 according to the present embodiment, since the SoC 82 and the amplifier element 151 are disposed at the position closer to the first fan 31A than to the second fan 31B as viewed from the upper side, they are heat exchanged with air having a smaller temperature rise than air on the downstream side (-Y side) having a larger temperature rise as a whole due to heat exchange, and thus can be effectively cooled.

In the projector 1 according to the present embodiment, since the end portions on the +Y side of the second cooling fins 112B are positioned on the +Y side of the -Y side end portion of the second board 112, the second cooling fins 112B can be disposed on the +Y side compared to the case where the second cooling fins 112B are disposed in contact with the -Y side of the second board 112, whereby the projector main body 3 can be reduced in size in the Y direction.

In the projector 1 according to the present embodiment, it has the branch duct 34 that forms the plurality of branch paths 37 for branching the air from the air blowing port 31C and leading the air to the opening section 38A and the opening sections 38B, 38C, and 38D, the cooling target can be cooled more effectively by setting the positions of the opening sections 38B, 38C, and 38D according to the cooling target.

The SoC 82 directly controls the fourth light source 28 mounted on the auxiliary board 90. The fourth light source 28 is controlled by pulse width modulation control. Since the SoC 82 directly controls the fourth light source 28 without interposing a driver or the like, the number of components can be reduced.

The SoC 82 is connected to the microcontroller 24 of the connection board 93, and indirectly controls the touch sensor 22 via the microcontroller 24.

That is, in the present embodiment, the SoC 82 directly or indirectly controls the LED 13, the fourth light source 28, and the touch sensor 22. In this way, since the SoC 82 controls a plurality of components such as the indicator 27 and the LED driver 12 together, the number of components can be reduced as compared with a case where circuits are separately provided.

The main board 81 includes the power supply circuit 83. The power supply circuit 83 is supplied with power via the AC adapter 20 and the power supply wiring 18. The power supply circuit 83 supplies electricity from the AC adapter 20 to the SoC 82, the LED 13, the forth light sources 28, the LED driver 12, various elements, and the like. Since the power supply circuit 83 is configured to supply electricity to a plurality of supply destinations, the circuit configuration can be simplified and the number of components can be reduced.

In the present embodiment, since the main board 81, the illumination board 11, the auxiliary board 90, and the connection board 93 are provided separately from each other, it is possible to disperse the heat generated in each board and suppress the influence on the projector 1.

### 6. Other embodiments

Although the preferred embodiments according to the present disclosure have been described above with reference to the accompanying drawings, it is needless to say that the present disclosure is not limited to such examples. The shapes, combinations, and the like of the respective constituent members shown in the above-described examples are merely examples, and various modifications can be made based on design requirements and the like without departing from the gist of the present disclosure.

For example, in the embodiment described above, the projector main body 3 has the rectangular shaped notch 14 in the bottom view of the projector main body 3. However, the shape of the notch is not particularly limited, and may be an oval shaped notch or a notch having a shape in which a part thereof is widened.

For example, when the number of LEDs as the second light source is small, the SoC may directly perform control without providing the LED driver.

In the embodiment described above, the AC adapter is used as the power supply adapter, and the electricity is supplied to the projector 1 by the AC adapter terminal provided on the base. However, the power supply adapter is not limited to the AC adapter, and an existing power adapter can be used. The power supply terminal can be changed depending on the power supply adapter to be used.

In the above described embodiment, the touch sensor 22 is provided with the oval shaped opening 22a. However, the touch sensor may be provided with a recess instead of the opening. In the case where the recess is provided in the touch sensor, the excess solder flows into the recess, and thus, the solder can be prevented from contaminating the touch sensor and affecting the touch sensor, thereby preventing a decrease in sensitivity.

The bonding between the touch sensor and the sensor wiring is not limited to solder, and an existing conductive bonding material can be used.

### 7. Summary of present disclosure

Hereinafter, a summary of the present disclosure is supplementary noted.

### Supplementary note 1

A projector includes a plurality of light sources; a drive element configured to control driving of the plurality of light sources; an integrated circuit element configured to control the drive element; a main board on which the drive element and the integrated circuit element are mounted; a housing configured to house the plurality of light sources and the main board; a partition section configured to partition an internal space of the housing into a first cooling flow path and a second cooling flow path; a first cooling device configured to cool the first cooling flow path; and a second cooling device configured to cool the second cooling flow path, wherein an amount of heat released to the second cooling flow path is larger than an amount of heat released to the first cooling flow path and a cooling capacity of the second cooling device is higher than a cooling capacity of the first cooling device.

According to this, by using the first cooling device and the second cooling device disposed according to the amount of heat released into the first cooling flow path and the second cooling flow path, the projector can be effectively cooled when a plurality of light sources are provided.

### Supplementary note 2

The projector according to supplementary note 1, wherein the first cooling device has a first fan that is disposed in the first cooling flow path on one side in a first direction, which is orthogonal to a height direction of the housing, and that is configured to blow sucked air to the first cooling flow path and a second fan that is disposed in the first cooling flow path on an other side in the first direction and that is configured to blow the air in the first cooling flow path to the other side in the first direction, the second cooling device has a third fan that is disposed in the second cooling flow path on one side in the first direction and that is configured to blow the sucked air to the other side in the first direction, and the third fan has an intake air volume larger than an intake air volume of the first fan.

According to this, the second cooling flow path, which releases a large amount of heat, is cooled with a large amount of air from the third fan, and the first cooling flow path, which releases a small amount of heat, is cooled with an amount of air from the first fan smaller than that from the third fan, the projector can be effectively cooled.

### Supplementary note 3

The projector according to supplementary note 2, wherein a first light source, a second light source, and a third light source are provided as the plurality of light sources, the first light source is provided with a first cooling fin, the second light source is provided with a second cooling fin, the third light source is provided with a third cooling fin, the first cooling fin and the main board are disposed in the first cooling flow path, and the second cooling fin and the third cooling fin are disposed in the second cooling flow path.

According to this, the first cooling fin and the main board disposed in the first cooling flow path can be cooled by using the first fan and the second fan, and the second cooling fin and the third cooling fin disposed in the second cooling flow path can be cooled by using the third fan.

### Supplementary note 4

The projector according to supplementary note 3, wherein the first light source, the second light source, and the third light source are disposed in the first cooling flow path.

According to this, the first light source, the second light source, and the third light source can be directly cooled by the first fan and the second fan, and also the second light source and the third light source can be indirectly cooled by the third fan via the second cooling fin and the third cooling fin.

### Supplementary note 5

The projector according to supplementary note 4, further including a heat pipe that is disposed across the first cooling flow path and the second cooling flow path and that is in contact with the second light source and the second cooling fin.

According to this, the second light source can be directly cooled by the first fan and the second fan, and can also be indirectly cooled via the second cooling fin and the heat pipe.

### Supplementary note 6

The projector according to supplementary note 5, wherein the heat pipe is in contact with an end portion of the second light source on the other side in the first direction and an end portion of the second cooling fin on one side in the first direction is positioned on one side in the first direction with respect to the end portion of the second light source on the other side in the first direction as viewed from the height direction of the housing.

According to this, the projector can be downsized in the first direction.

### Supplementary note 7

The projector according to any one of supplementary notes 3 to 6, wherein the integrated circuit element is disposed at a position closer to the first fan than to the second fan as viewed from the height direction of the housing.

According to this, since the heat exchange is performed with the air having a smaller temperature rise than the air on the downstream side having a larger temperature rise due to the heat exchange, the integrated circuit element can be effectively cooled.

### Supplementary note 8

The projector according to any one of supplementary notes 3 to 7, further including an acoustic device and an amplifier element that is mounted on the main board and that is configured to transmit a signal to the acoustic device, wherein the amplifier element is disposed at a position closer to the first fan than to the second fan as viewed from the height direction of the housing.

According to this, since heat exchange is performed with the air having a smaller temperature rise than the air on the downstream side having a larger temperature rise due to heat exchange, the amplifier element can be effectively cooled.

### Supplementary note 9

The projector according to any one of supplementary notes 3 to 8, further including a branch duct that is provided at an air blowing port of the first fan and that forms a plurality of branch paths, each of the branch paths having an opening section that opens at a predetermined opening section position in the first cooling flow path, the branch paths branching air from the air blowing port and guiding the air to the opening sections.

According to this, the cooling target can be cooled more effectively by setting the position of the opening section according to the cooling target.

What is claimed is:

1. A projector comprising:
a plurality of light sources;
a drive element configured to control driving of the plurality of light sources;
an integrated circuit element configured to control the drive element;
a main board on which the drive element and the integrated circuit element are mounted;
a housing configured to house the plurality of light sources and the main board;
a partition section configured to partition an internal space of the housing into a first cooling flow path and a second cooling flow path;
a first cooling device configured to cool the first cooling flow path; and
a second cooling device configured to cool the second cooling flow path, wherein
an amount of heat released to the second cooling flow path is larger than an amount of heat released to the first cooling flow path and
a cooling capacity of the second cooling device is higher than a cooling capacity of the first cooling device.

2. The projector according to claim 1, wherein
the first cooling device has
a first fan that is disposed in the first cooling flow path on one side in a first direction, which is orthogonal to a height direction of the housing, and that is configured to blow sucked air to the first cooling flow path and
a second fan that is disposed in the first cooling flow path on an other side in the first direction and that is configured to blow the air in the first cooling flow path to the other side in the first direction,
the second cooling device has a third fan that is disposed in the second cooling flow path on one side in the first direction and that is configured to blow the sucked air to the other side in the first direction, and
the third fan has an intake air volume larger than an intake air volume of the first fan.

3. The projector according to claim 2, wherein
a first light source, a second light source, and a third light source are provided as the plurality of light sources,
the first light source is provided with a first cooling fin,
the second light source is provided with a second cooling fin,
the third light source is provided with a third cooling fin,
the first cooling fin and the main board are disposed in the first cooling flow path, and
the second cooling fin and the third cooling fin are disposed in the second cooling flow path.

4. The projector according to claim 3, wherein
the first light source, the second light source, and the third light source are disposed in the first cooling flow path.

5. The projector according to claim 4, further comprising:
a heat pipe that is disposed across the first cooling flow path and the second cooling flow path and that is in contact with the second light source and the second cooling fin.

6. The projector according to claim 5, wherein
the heat pipe is in contact with an end portion of the second light source on the other side in the first direction and
an end portion of the second cooling fin on one side in the first direction is positioned on one side in the first direction with respect to the end portion of the second light source on the other side in the first direction as viewed from the height direction of the housing.

7. The projector according to claim 3, wherein
the integrated circuit element is disposed at a position closer to the first fan than to the second fan as viewed from the height direction of the housing.

8. The projector according to claim 3, further comprising:
an acoustic device and
an amplifier element that is mounted on the main board and that is configured to transmit a signal to the acoustic device, wherein
the amplifier element is disposed at a position closer to the first fan than to the second fan as viewed from the height direction of the housing.

9. The projector according to claim 3, further comprising:
a branch duct that is provided at an air blowing port of the first fan and that forms a plurality of branch paths, each of the branch paths having an opening section that opens at a predetermined opening section position in the first cooling flow path, the branch paths branching air from the air blowing port and guiding the air to the opening sections.
